(19) United States
(12) Patent Application Publication
(10) Pub. No.: US 2004/0156595 A1
(43) Pub. Date: Aug. 12, 2004

(54) Optical coupling device and optical connector

(76) Inventors: Andreas Stockhaus, Berlin (DE); Mario Festag, Berlin (DE)

Correspondence Address: Thomas G Eschweiler, Eschweiler & Associates, National City Bank Building, 629 Euclid Avenue Suite 1210, Cleveland, OH, 44114, US

(21) Appl. No.: 10/484,395

(22) PCT Filed: Jul. 31, 2001
(86) PCT No.: PCT/DE01/02913

(51) Int. Cl. G02B 6/36

(52) U.S. Cl. 385/88

(57) ABSTRACT

The invention relates to an optical coupling device ice comprising at least one optical connector (1) which has at least one optical fiber end piece (4) which is axially spring-mounted by means of a spring (6). A coupling partner (3) of the optical connector (1)is arranged in relation to a metal structure (9) in such a way that an optical port of the coupling partner (3) protrudes through a cut-out (91) in the metal structure (9). The invention also relates to a corresponding optical connector. According to the invention, the spring (6) consists of a ceramic material or contains a ceramic material. The invention makes it possible to reduce electromagnetic perturbing radiation especially in the region of a discontinuity in the metal structure in which the optical connector is arranged.

The invention relates to an optical coupling device according to the precharacterizing clause of claim 1 and an optical connector according to the precharacterizing clause of claim 8.

It is known to arrange optoelectronic transceivers for optical data transmission on a printed circuit board. Known in particular are pluggable transceivers of a small type of construction, referred to as small form-factor pluggable (SFP) transceivers, which are arranged in a housing on a printed circuit board. The transceivers have, in a way known per se, optoelectronic transducers such as a Fabric [sic] Perot laser or VCSEL laser and a photodiode. Coupling in or out of infrared light between a transceiver and an optical network takes place via a connector receptacle or generally an optical port, into which an optical connector can be inserted.

In this case it is customary to arrange the printed circuit board with the optoelectronic transceiver in a metal housing, for instance the housing of a mainframe computer or server. Among the purposes of the housing is to provide shielding from electromagnetic interference, which occurs in particular in the case of high clock-pulse rates in the gigahertz range. There is, however, the problem the [sic] the optical port must be led out of the housing with the inserted optical connector or at least a cable connected to the optical connector. Via the discontinuity or opening produced in this way in the housing wall (backplane), electromagnetic interference is emitted from the interior of the housing to the outside. The problem increases with increasing clock-pulse rates of the transceivers used.

There are a number of solution proposals to minimize the electromagnetic emission. For example, in the case of a cable which is led in through the housing wall, the cable shielding is electrically connected to the housing bushing.

In the case of optical connectors, however, this possibility does not exist. Instead, there are electromagnetic transfers between conducting parts of the optical connector and conducting parts of the transceiver, which are of a different potential than that of the housing. In the case of the latter, this concerns for example signal ground areas of the transceiver, i.e. areas which are connected to “Signal Ground”. The signals transferred to the conducting parts of an optical connector are radiated to the outside from these without any interference.

Conducting or metal parts of an optical connector to which a transfer of electromagnetic interference takes place are, in particular, steel springs, which are often arranged in an optical connector for biasing an optical fiber end piece (ferrule). An optical connector with steel springs is described for example in U.S. Pat. No. 6,234,682. Attempts to prevent this transfer by using springs made of a plastic material have been unsuccessful to the extent that plastic springs lose their spring tension under continuous loading and are therefore not suitable for use.

The present invention is based on the object of providing an optical coupling device and an optical connector which effectively reduce interference emissions caused by electromagnetic waves, even in the case of high frequencies.

This object is achieved according to the invention by an optical coupling device with the features of claim 1 and an optical connector with the features of claim 8. Preferred and advantageous configurations of the invention are specified in the subclaims.

It is accordingly provided by the invention that the spring of the optical connector consists at least partly of a ceramic material, i.e. contains a ceramic material or consists completely of such a material. Use of a non-metallic spring made of a ceramic material prevents electromagnetic interference from being transferred to the optical connector and then emitted from the latter in the manner of an antenna. This considerably reduces in particular the electromagnetic interference in the region of the discontinuity of a metal structure through which the optical port of the coupling partner of the optical connector protrudes. At the same time, a ceramic spring provides a spring with a spring constant that is substantially constant even in continuous operation. This follows from the inherent properties of ceramic materials.

In a preferred configuration of the invention, the spring consists of an oxide-ceramic material, in particular aluminum titanate or aluminum oxide. The production of the spring in this case takes place for example by working the spring from an elongate extruded ceramic tube by means of grinding. A further production process envisages extruding a wire from a ceramic material, winding the wire into a spring and then firing it or making it set.

In a further preferred configuration of the invention, the spring consists of a plastic in which ceramic particles are incorporated and made to set. The ceramic particles may in turn be, for example, particles of aluminum titanate or aluminum oxide.

The production of such a spring preferably takes place by injection molding with ceramic material. In this case, ceramic particles are incorporated in a polymer matrix and molded in a way similar to a plastic part in an injection mold and subsequently the binder is removed and they are made to set. In so-called “ceramic injection molding”, the plastic is in this case removed completely, so that nothing but ceramic material is left behind. However, it is within the scope of the invention for the plastic not to be removed completely, so that a plastic with ceramic particles incorporated in it is obtained. The desired physical properties of the material can in this case be set in particular by the proportion of ceramic particles contained.

The spring is preferably a cylindrical helical compression spring. Depending on the type of connection of the spring to the optical fiber end piece, however, other springs may also be used, such as for instance cup springs.

In one configuration, the optical connector is formed with one channel, the optical fiber end piece containing an optical fiber. The optical fiber in this case couples with an associated optical fiber of a coupling partner. However, it is similarly within the scope of the invention to form the connector with more than one channel, the optical fiber end piece possibly containing a multiplicity of optical fibers. A typical application in the latter case is data transmission over a number of parallel optical data channels. All that is important is that the spring of the connector is a ceramic spring, i.e. the spring consists of a ceramic material or contains such a material and is in that case non-conducting.

The invention is explained in more detail below on the basis of several exemplary embodiments with reference to the figures of the drawing, in which:

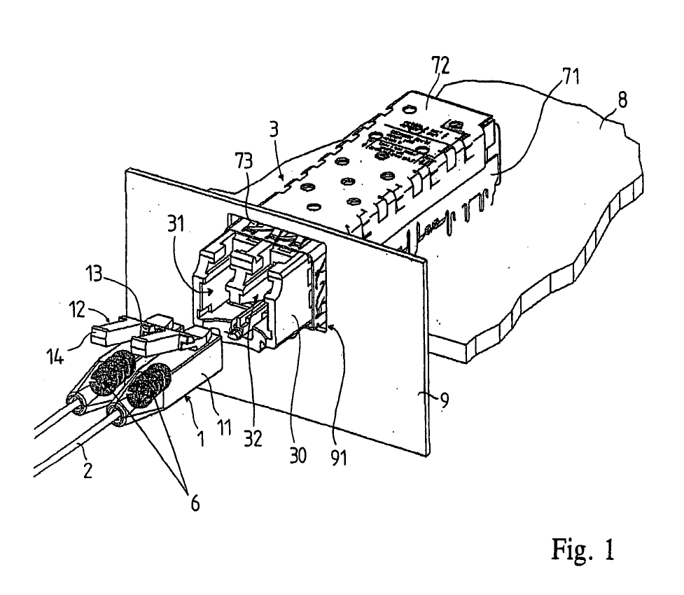

FIG. 1 shows a perspective view of a coupling device with an optical connector and a coupling partner;

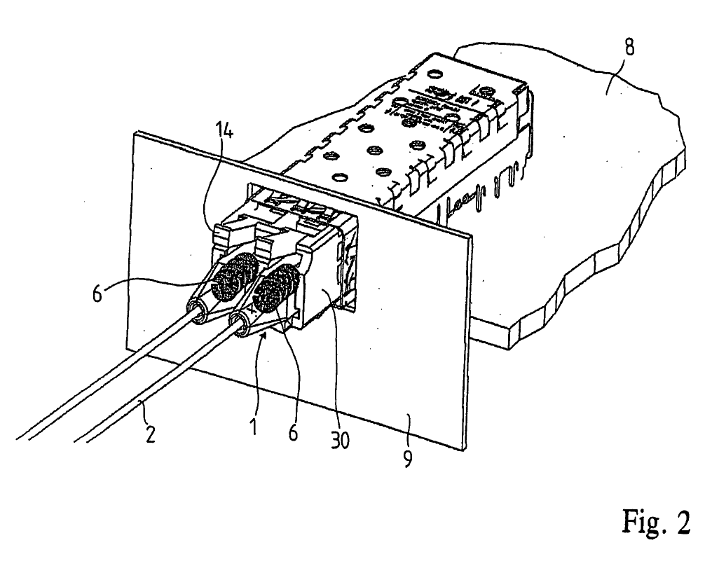

FIG. 2 shows a perspective view of the coupling device of FIG. 1 after insertion of the optical connector into the coupling partner;

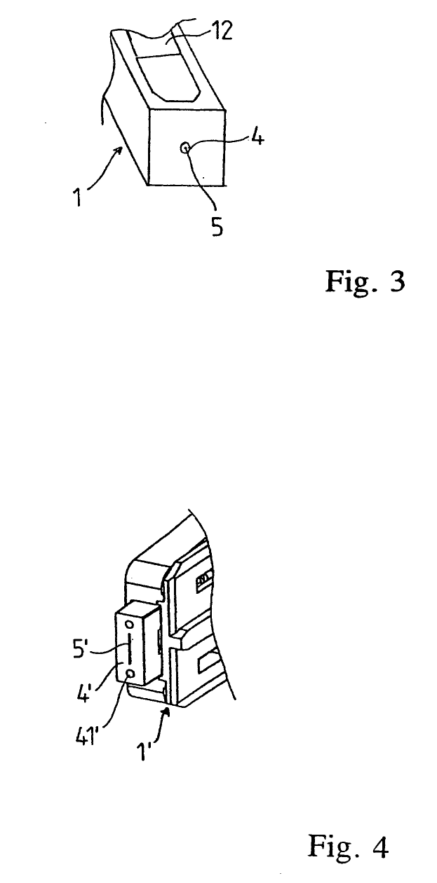

FIG. 3 schematically shows a perspective view of the front part of an optical connector corresponding to FIG. 1 and

FIG. 4 schematically shows a perspective view of the front part of an alternative optical connector.

FIG. 1 shows two identically formed optical connectors 1, which are respectively fitted on the end of an optical cable 2 and are intended for being inserted into an optical port 30 with two connector receptacles 31, 32 of a transceiver 3.

The optical connectors 1 each have a plastic housing 11, in which there is arranged, in a way known per se, an optical end piece 4, usually referred to as a ferrule, which is spring-mounted in the direction of insertion in the housing and protrudes from the front side of the connector 1 (see FIG. 3). The ferrule 4 is in the present exemplary embodiment a ceramic ferrule in which an optical fiber 5 is guided.

Provided for the spring-mounting of the ferrule 4 is a schematically represented cylindrical helical compression spring 6, which exerts a spring pressure on the ferrule 4 in the axial direction. The spring 6 consists of a ceramic material, for example aluminum titanate or aluminum oxide. It may likewise be provided that the spring 6 consists of ceramic particles set in plastic.

The optical connector 1 has, furthermore, a latching element 12 with latching lugs 13 and an actuating lever 14. The latching element 12 serves for latching the optical connector 1 in corresponding structures of the connector receptacle 31,32 of the transceiver 3.

Alternatively, the two connectors 1 are formed as a duplex connector and for this purpose connected to each other by a plastic clip (not represented).

The transceiver 3 has in a way known per se a transmitting component (for example a Fabric [sic] Perot laser or VCSEL laser) and a receiving component (for example a photodiode) (not separately represented), which respectively receive or transmit optical signals via the optical port 30 with the two connector receptacles 31, 32. Alternatively, the transceiver has only one transmitting component or one receiving component, the optical port then having only one connector receptacle.

The transceiver 3 is pushed into a housing 7, which is mounted on a printed circuit board 8 and serves for securing, shielding and contacting the transceiver 3. The housing 7 forms a sheet-metal cage, which usually consists of a copper alloy or steel alloy and is formed by a lower part 71, which is connected to the printed circuit board 8, and an upper part 72, which can be mounted on said lower part. A connector part (not represented) arranged in the housing 7 serves for the contacting of corresponding contacts of the transceiver 1.

According to FIGS. 1 and 2, the transceiver 3 is arranged behind a metal housing wall or backplane 9, which is part of the housing of for example a server or other computer. The transceiver 3 is arranged in the backplane 9 in such a way that the optical port 30 of the transceiver protrudes through an opening 91 in the backplane 9, while the optoelectronic components (laser diode, photodiode) are arranged behind the backplane 9. The housing 7 of the transceiver 3 is in this case coupled to the metal backplane 9 via contact springs 73. The opening 91 in the backplane 9 represents a discontinuity, via which electromagnetic interference can be coupled out to the outside.

In FIG. 2, the two connectors 1 are inserted in the optical port 30 of the transceiver 3. The latching lugs 13 of the latching element 12 are in this case releasably latched with corresponding structures of the connector receptacles 31, 32. The ferrule 4 with the optical fiber 5 couples with a corresponding ferrule of the transceiver (not represented). Secure coupling with the respective ferrule or else other structures of the coupling partner 3 is provided by the ceramic spring 6 and the axial spring force provided by the ceramic spring 6.

The optical connector exclusively comprises non-metallic components. In particular, the spring 6 consists of a non-metallic material, namely a ceramic material. The ceramic material provides a spring force that decreases only slightly even under continuous loading of the spring 6.

Since the spring 6 of the optical connector consists of a ceramic material, the transfer of electromagnetic interference to the spring and subsequent emission of the interference from the spring to the exterior is effectively prevented. The emission of electromagnetic interference through the opening 91 in the backplane 9 is thereby also reduced even in the case of high signal frequencies in the gigahertz range. This makes it posssible for the first time to allow the optical port 30 of the transceiver to protrude from the backplane 9 in an easily accessible way even in the case of high signal frequencies.

In an alternative configuration, it is provided that the optical connector is formed with more than one channel. The front part of such a connector 1′ is represented in FIG. 4. The optical fiber end piece 4′, likewise referred to as a “ferrule”, contains not only openings 41′ for positioning pins but also a multiplicity of optical fibers 5′. The fiber end piece 4′ is, for example, a standard MT ferrule. It is in turn provided here that the spring arranged in the connector 1′ is formed from a ceramic material.

The invention is not restricted in its configuration to the exemplary embodiments represented above. In particular, the invention is not restricted to special optical connectors or their specific arrangement in a coupling partner or with respect to a metal backplane. All that is important is that a spring of an optical connector consists of a ceramic material or contains such a material and consequently can emit electromagnetic interference to a reduced extent or even not at all.

1. An optical coupling device with
at least one optical connector (1), which has at least one optical fiber end piece (4), which is spring-mounted axially by means of a spring (6),
a coupling partner (3), in particular an optoelectronic transceiver, which has an optical port (30) for receiving the at least one optical connector (1) and also at least one optoelectronic component, and
a metal structure (9), it being possible for the coupling partner (3) to be arranged in relation to the metal structure (9) in such a way that the optical port (30) protrudes through a cutout (91) in the metal structure (9) and is located outside the metal structure, while the optoelectronic component is located inside the metal structure,
characterized
in that the spring (6) of the optical connector (1) consists of a ceramic material or contains such a material.

2. The coupling device as claimed in claim 1, characterized in that the spring (6) consists of an oxide-ceramic material, in particular aluminum titanate or aluminum oxide.

3. The coupling device as claimed in claim 1, characterized in that the spring (6) consists of a plastic in which ceramic particles are incorporated and made to set.

4. The coupling device as claimed in at least one of claims 1 to 4, characterized in that the optical connector (1) is formed with one channel and the optical fiber end piece (4) contains an optical fiber (5).

5. The coupling device as claimed in at least one of claims 1 to 4, characterized in that the optical connector (1′) is formed with more than one channel and the optical fiber end piece (4′) contains a multiplicity of optical fibers (5′).

6. The coupling device as claimed in at least one of the preceding claims, characterized in that the connector (6) has actuable latching means (12, 13, 14) for a latching connection with the coupling partner (3).

7. The coupling device as claimed in at least one of the preceding claims, characterized in that the metal structure (9) is a housing wall of a computer, in particular of a mainframe computer or server.

8. An optical connector, in particular for an optical coupling device as claimed in claim 1, with at least one optical fiber end piece (4, 4′), which is spring-mounted axially by means of a spring (6),
characterized
in that the spring (6) consists of a ceramic material or contains such a material.

9. The optical connector as claimed in claim 8, characterized in that the spring (6) consists of an oxide-ceramic material, in particular aluminum titanate or aluminum oxide.

10. The optical connector as claimed in claim 8, characterized in that the spring (6) consists of a plastic in which ceramic particles are incorporated and made to set.

11. The optical connector as claimed in at least one of claims 8 to 10, characterized in that the spring (6) is a cylindrical helical compression spring.

12. The optical connector as claimed in at least one of claims 8 to 11, characterized in that the connector (1) has actuable latching means (12, 13, 14) for a latching connection with a coupling partner (13).
